(19) United States
(12) Patent Application Publication
(10) Pub. No.: US 2014/0217234 A1
(43) Pub. Date: Aug. 7, 2014

(54) AIRCRAFT PROPULSION ASSEMBLY

(71) Applicant: AIRCELLE, GONFREVILLE L'ORCHER (FR)

(72) Inventor: Nicolas DEZEUSTRE, LE HAVRE (FR)

(73) Assignee: AIRCELLE, GONFREVILLE L'ORCHER (FR)

(21) Appl. No.: 14/245,843

(22) Filed: Apr. 4, 2014

Related U.S. Application Data
(63) Continuation of application No. PCT/FR2012/052259, filed on Oct. 5, 2012.

(30) Foreign Application Priority Data
Oct. 6, 2011 (FR) 11/59010

(51) Int. Cl. B64D 27/10

(52) U.S. Cl. CPC B64D 27/10
USPC 244/54

(57) ABSTRACT

An aircraft propulsion assembly includes a turbojet engine, a support providing a transfer of force torque to an aircraft from a suspension assembly, and the suspension assembly interposed between the support and the turbojet engine. The suspension assembly includes a device for absorbing thrust forces, an upstream suspension fasteners mounted on a fan housing and an intermediate housing of the turbojet engine. In particular, the suspension assemble further includes a main upstream suspension fastener to absorb a moment (Mx) along an axis (X) of the turbojet engine and forces (Fy and Fz) in a plane perpendicular to the axis (X), and a pair of additional upstream suspension fasteners separate from the main upstream suspension fastener to absorb a moment (Mz) along an axis (Z) and a moment (My) along an axis (Y) and forces (Fx) along the axis (X).

### CROSS-REFERENCE TO RELATED APPLICATIONS

This application is a continuation of International Application No. PCT/FR2012/052259, filed on Oct. 5, 2012, which claims the benefit of FR 11/59010, filed on Oct. 6, 2011. The disclosures of the above applications are incorporated herein by reference.

### FIELD

The present disclosure generally relates to an aircraft propulsion assembly.

### BACKGROUND

The statements in this section merely provide background information related to the present disclosure and may not constitute prior art.

An aircraft propulsion assembly is formed by a nacelle and a turbojet engine, the assembly being intended to be suspended to a stationary structure of the aircraft, for example a wing or the fuselage, by means of a pylon fastened to the turbojet engine and/or to the nacelle.

The turbojet engine ordinarily comprises a so-called upstream section comprising a fan provided with blades and a so-called downstream section housing a gas generator.

The fan blades are surrounded by a fan housing enabling to mount the turbojet engine onto the nacelle.

Furthermore, in order to provide the force transmission at the interface between the turbojet engine and the stationary structure of the aircraft, the pylon comprises, for example, a rigid box type structure, formed by the assembling of spars and lateral panels.

A suspension assembly is provided between the turbojet engine and the pylon, this assembly comprising a plurality of suspension fasteners forming a system for absorbing the forces distributed along the pylon.

More particularly, such a suspension assembly comprises several upstream suspension fasteners secured to the fan housing or the intermediate housing and downstream suspension fasteners which are secured to a turbojet engine main housing.

This suspension assembly further comprises a device for absorbing the thrust forces generated by the turbojet engine.

Such a device may take the form of two lateral rods, located at the output of the annular channel of the fan and connected on one side to a downstream portion of the fan housing and on the other side, to a downstream fastener fixed onto the turbojet engine main housing.

A recurrent issue of this type of suspension assembly resides in the torque exerted along a transversal direction of the aircraft, present due to the shift between the thrust absorbing point of the rods on the fan housing and the main longitudinal axis of the turbojet engine.

A distortion of the turbojet engine occurs due to this torque and the standard suspension assembly provided for bearing the turbojet engine thrust forces.

Such a distortion of the turbojet engine leads to friction between the fan housing and the turning components of the propulsion assembly such as the blades or vanes of the fan and/or between the vanes of the turbojet engine and the latter main housing.

This friction damages the turning components, limiting the service life of the turbojet engine and reducing its performance.

Such a distortion may also lead to clearances between the turning components of the propulsion assembly and the fan and/or main housing of the turbojet engine, which also reduce the turbojet engine performance.

Various suspension assemblies have been designed to limit this recurrent turbojet engine distortion problem. However, they are not entirely satisfactory.

It is particularly known, a suspension assembly comprising several upstream hyperstatic suspension fasteners, each designed in such a manner as to absorb forces being exerted along the three directions and the three moments and a downstream suspension fastener mounted between the pylon and an outer or ejection housing of the turbojet engine designed in such a manner as to absorb forces being exerted along the vertical direction of the turbojet engine. In such an assembly, the device for absorbing thrust forces is removed.

Such a suspension assembly renders tricky the redundancy of the load pathways and hence requires a complex inspection policy.

Such a suspension assembly further implies the use of large dimension suspension fasteners and provided with numerous stiffeners to overcome the removal of the force absorbing device and, this unfavorably affects the mass of the aircraft propulsion assembly.

This excess of mass of the propulsion assembly and the encumbrance associated with the turbojet engine suspension fasteners hinder the turbojet engine performance.

Thus, there is a need for a suspension assembly allowing to remedy to the aforementioned drawbacks.

### SUMMARY

The present disclosure provides an aircraft propulsion assembly which effectively reduces turbojet engine distortion while providing a mass gain relatively to the existing suspension assemblies, thus improving the propulsion assembly engine performance.

To this regard, the present disclosure provides an aircraft propulsion assembly comprising a turbojet engine, a support providing the transfer of force torque to the aircraft from a suspension assembly as well as a suspension assembly interposed between said support and the turbojet engine, the suspension assembly comprising a device for absorbing thrust forces of the turbojet engine mounted on an intermediate housing or at the front of a main housing of said turbojet engine and on said support, characterized in that the suspension assembly further comprises the following upstream suspension fasteners mounted on a fan housing and/or on said intermediate housing of said turbojet engine:

at least one main upstream suspension fastener, configured in such a manner as to absorb at least a moment along a longitudinal axis of the turbojet engine as well as the forces in a plane perpendicular to the longitudinal axis of said turbojet engine, and

at least one pair of additional upstream suspension fasteners separate from the main suspension fastener and configured such as to absorb at least a moment along the axis leading from the longitudinal axis of the turbojet engine to the longitudinal axis of the support and associated with the device for absorbing thrust forces, a moment along the axis perpendicular to the longitudinal axis of the turbojet engine and to the axis leading from the longitudinal axis of the turbojet engine to the longitudinal axis of the support and the forces along the longitudinal axis of the turbojet engine.

Thus, by providing an upstream set of fasteners capable of absorbing all of the six components of forces and moments in a highly localized manner upstream of the turbojet engine combustion chamber, it is possible to better manage the force absorption, and particularly be able to remove the rear fastener if need be.

According to other features of the present disclosure, taken alone or in combination:

said suspension device comprises load pathway redundancies by means of pairs of suspension fasteners, to provide resumption of the useful load pathways in the event of rupture of the main load pathway;

the suspension assembly is isostatic;

said pair of additional upstream suspension fasteners extends in a plane defined by the longitudinal axis of the turbojet engine and the axis leading from the longitudinal axis of the turbojet engine to the longitudinal axis of the support, each fastener being connected at an upstream end upstream of the support and, and at a downstream end, to the outer periphery of an outer ferrule of the intermediate housing or the fan housing;

said pairs of additional upstream suspension fasteners are mounted on the outer ferrule of the intermediate housing or on the fan housing, symmetrically with respect to the median plane defined by the longitudinal axis of the turbojet engine and by the axis leading from the longitudinal axis of the turbojet engine to the longitudinal axis of the support;

said additional upstream suspension fasteners are mounted on either side of the main upstream suspension fastener, the latter extending in a plane perpendicular to the longitudinal axis of the turbojet engine;

each pair of additional upstream suspension fasteners comprises two parallel latching rods and extending in a plane defined by the axis leading from the longitudinal axis of the turbojet engine to the longitudinal axis of the support and by the longitudinal axis of the turbojet engine, connected at an upstream end, by means of a yoke, to a fixing support secured to the support and, at a downstream end, to the intermediate housing or the fan housing via a latching support;

one of the fasteners of the pair of additional upstream suspension fasteners is configured in such a manner as to absorb in association with said main suspension fastener, the moment along the axis leading from the longitudinal axis of the turbojet engine to the longitudinal axis of the support;

said fastener of the pair of additional upstream suspension fasteners extends in a plane perpendicular to the longitudinal axis, allowing to absorb forces perpendicular to this axis and to the axis leading from the longitudinal axis to the longitudinal axis of the support.

The present disclosure also relates to an aircraft comprising at least one propulsion assembly such as that which has just been introduced.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a lateral view of an aircraft propulsion assembly comprising a suspension assembly according to one form of the present disclosure;

FIG. 2 is a front view of the aircraft propulsion assembly of FIG. 1;

FIG. 3 is a rear perspective view of the aircraft propulsion assembly of FIG. 1;

FIG. 4 is an enlarged view of area A of FIG. 3;

FIG. 5 is an enlarged view of area B of FIG. 1;

FIG. 6 is an enlarged view of area C of FIG. 1;

FIG. 7 is a partial perspective view of upstream suspension fasteners interposed between a ferrule of intermediate housing of the turbojet engine and a pylon of the assembly of FIG. 1, seen downstream of the propulsion assembly;

FIG. 8 is a perspective view of the suspension fasteners of FIG. 7, seen from below;

FIG. 9 illustrates in partial perspective another form of upstream suspension fasteners interposed between a ferrule of intermediate housing of the turbojet engine and a pylon, seen downstream of the propulsion assembly;

FIG. 10 is an axial view of the suspension fasteners of FIG. 9;

FIG. 11 represents a schematic cross-section of a propulsion assembly, on which the suspension assemblies can fasten onto according to the present disclosure; and

FIG. 12 illustrates the axis system used in the described aircraft propulsion assemblies.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

It is worth noting that on this set of figures, the axes that connect the components are in general not represented.

With reference to FIG. 12, it is worth noting that a point has been made of defining in the description a three axis reference X, Y, Z, these three axes representing:

the longitudinal direction of the turbojet engine for axis X,

the direction leading from the longitudinal axis of the turbojet engine to the longitudinal axis of the pylon for direction Z and,

the orthogonal direction to X and Z for axis Y.

In the case of a propulsion assembly mounted under the wing, the axis Z is generally vertical.

In the following description, the vertical axis will be assimilated to axis Z, although the propulsion assembly is mounted in another configuration, such as for example in rear fuselage, this is for the sake of simplification.

It is also worth noting that terms upstream and downstream are meant with respect to the travelling direction of the aircraft encountered following a thrust exerted by the turbojet engine.

Furthermore, the following forces and moments will be taken into account:

Fx the forces along an axis substantially parallel with axis X, and a Moment Mx substantially around this axis;

Fy the forces along an axis substantially parallel with axis Y and a Moment My substantially around this axis;

Fz the forces along an axis substantially parallel with axis z and a Moment MZ substantially around this axis.

In the following description, the term force generally describes the “force” component of the force torque, composed of three forces and three moments, along each of the three axes X, Y and Z.

Likewise, in the following description, the force absorptions in the three main directions and the moment absorptions are substantially in aforementioned directions X, Y and Z.

A limited angle with respect to these directions due to the design constraints such as described hereinafter does not change the overall functioning of the suspensions and remains within the scope of this present disclosure.

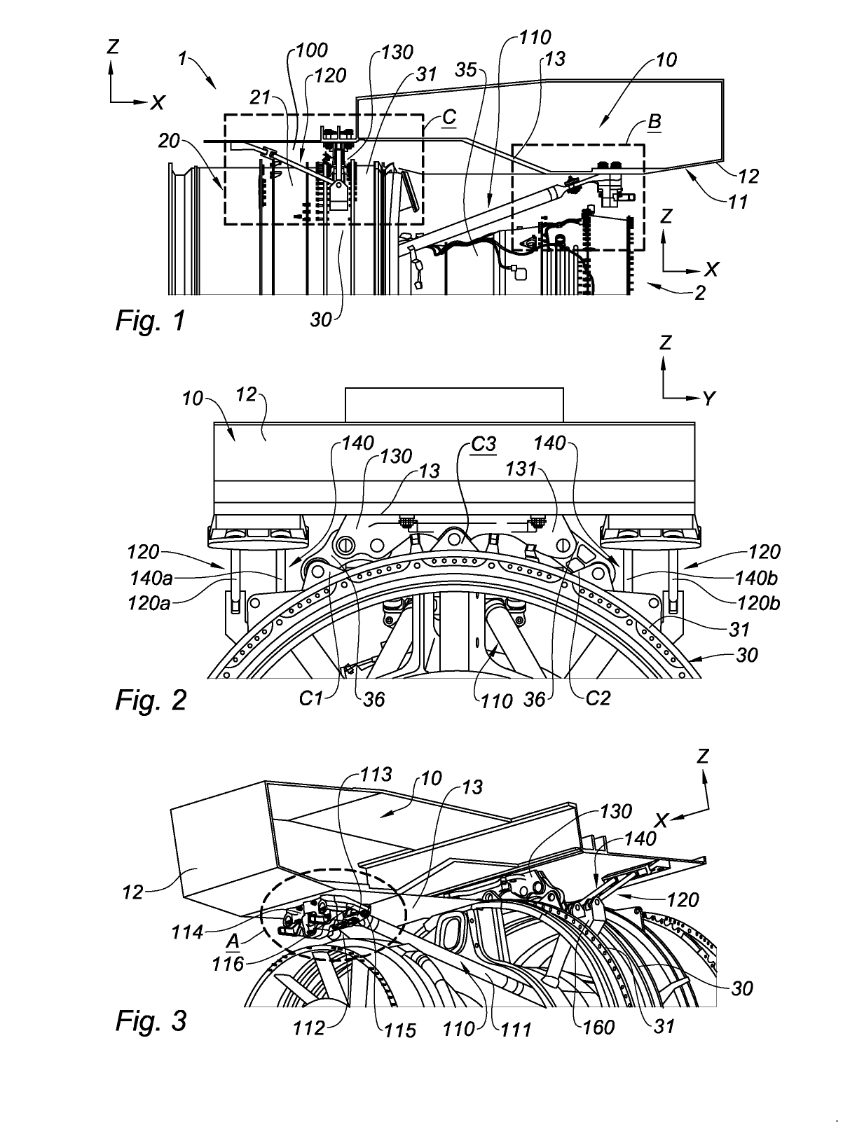

With reference to FIG. 1, can be seen a portion of an aircraft propulsion assembly 1 according to a first form of the present disclosure.

Generally, this aircraft propulsion assembly 1 is formed, in particular, by a nacelle (not represented), a turbojet engine 2, a pylon 10 and a suspension assembly 100 providing the fixing of the turbojet engine 2 under this pylon 10.

This aircraft propulsion assembly 1 is intended to be suspended to a stationary structure of the aircraft (not represented), for example under a wing or on the fuselage, by means of the pylon 10.

As for the pylon 10, it takes the form of a rigid longitudinal structure 11 and, more particularly, of a structure comprising a rigid box 12 capable of transmitting the force torque between the turbojet engine 2 and the aircraft structure.

This box 12 substantially extends along direction X.

It is formed of upper and lower spars 13, connected together by lateral panels.

The pylon 10 is known by the skilled person and will not be detailed any further.

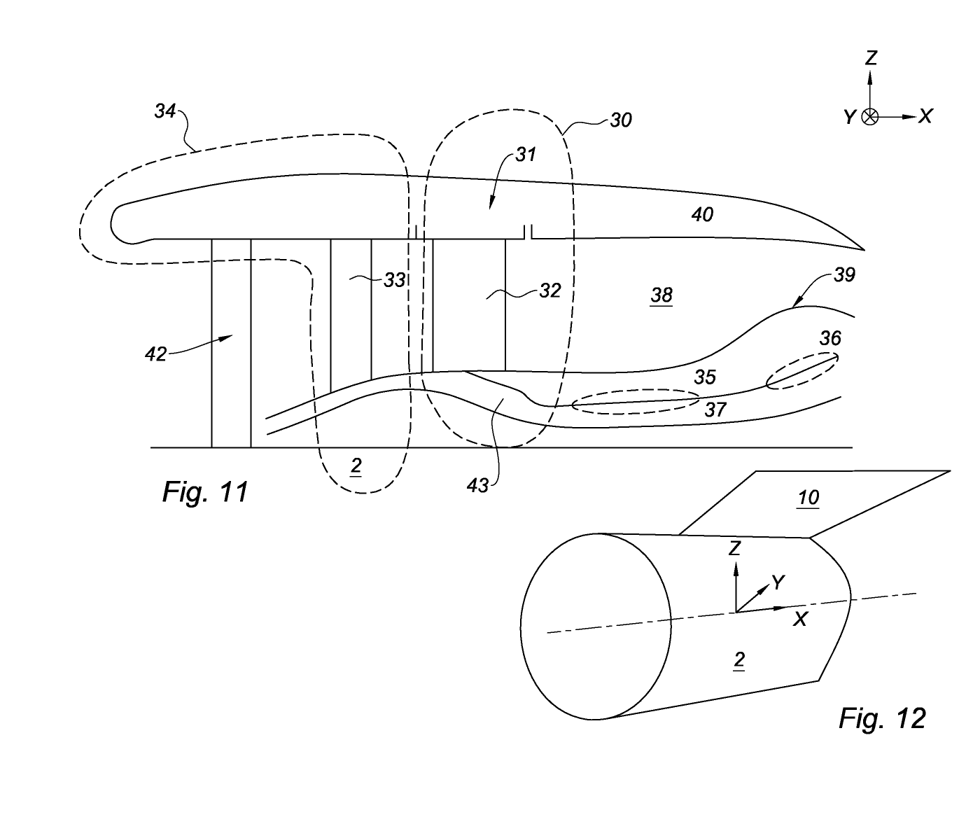

FIG. 11 describes the environment of the turbojet engine 2, by way of non-limiting example for the present disclosure.

The turbojet engine 2 comprises a fan 42 delivering an annular flow with a main exhaust flow which supplies the turbojet engine 2 driving the fan 42 and a secondary flow 38 which is ejected into the atmosphere while providing an important fraction of aircraft thrust.

The fan 42 is contained, as can be seen on FIG. 1, in a fan housing 34 which channels the secondary flow 38 downstream.

This housing 34 defines a portion of the nacelle inner wall and substantially exhibits the shape of an annular ferrule.

This fan housing 34 is adapted to surround the fan 42 of the turbojet engine 2 composed substantially of a rotating shaft and a plurality of fan blades.

The housing 34 may bear a plurality of blades 33 for straightening the flow allowing to straighten the secondary air flow 38 generated by the fan.

The fan 42 is rotatably mounted on a stationary hub 43 which can be connected to the fan housing 34 by a plurality of stationary arms 32 located downstream of the blades 33 or directly by these blades 33.

In this second configuration, the straightening blades 33 act as force transmitters in complement with or instead of the connecting arms 32.

They can thus be placed in the intermediate housing 30 instead of the fan housing 34.

The fan housing 34 is connected at its downstream end to an intermediate housing 30 belonging to the nacelle median section.

The secondary air flow 38 generated by the fan also crosses the wheel formed by the intermediate housing 30.

The intermediate housing 30 is a structural member which comprises the hub 43, an outer annular ferrule 31 and possibly, the radial connecting arms 32 and flow straighteners 33 which connect the hub 43 to the outer ferrule 31.

This housing 30 may be achieved in several portions or not.

Downstream of this intermediate housing 30, the secondary flow 38 stream is internally delimited by the outer 40 and inner 39 walls of the potential thrust reverser.

The inner wall 39 surrounds a cylindrical envelope called main housing 35 which surrounds the body of the turbojet engine 2 and which extends from the hub 43 of the intermediate housing 30 to an exhaust housing 37 located at the output of the turbine.

The different housings can be secured together.

As for the suspension assembly 100, it allows to transmit to the aircraft the mechanical forces of the turbojet engine 2 and the forces coming from the nacelle transmitted by the turbojet engine 2 during its different operating regimes.

The loads to be taken into consideration are oriented along the three main directions (forces and moments).

These are, in particular, inertial loads of the turbojet engine 2, generated by the rotation of this turbojet engine turning members, its thrust, aerodynamic loads or even the torque absorption around axis X of the turbojet engine 2.

According to the present disclosure, in a first form illustrated in FIGS. 1 to 8, the suspension assembly 100 comprises a the turbojet engine 2 device for absorbing thrust forces 110 mounted, upstream, on the intermediate housing 30 or at the front of the main housing 35 and, downstream, on the pylon 10.

The suspension assembly also comprises upstream suspension fasteners mounted on the outer ferrule 31 of the intermediate housing 30 and/or on the fan housing 34:

These upstream suspension fasteners are the following:

a main upstream suspension fastener 130, configured such as to absorb, in particular, the moment Mx along the longitudinal axis of the turbojet engine as well as the forces Fy and Fz respectively along the transverse and vertical directions, and

at least one pair 120, 140 of additional upstream suspension fasteners 120a, 120b, 140a, 140b separate from the main suspension fastener 130 and configured such as to absorb, in particular, a moment Mz along the turbojet engine vertical axis and, associated with the thrust absorbing device 110, a moment My along the turbojet engine transversal axis and the force FX along the turbojet engine axis.

As for the device for absorbing thrust forces 110, the latter is described in association with FIGS. 1 and 3 to 5.

The device 110 for absorbing thrust forces is associated with the pair 120, 140 of upstream suspension fasteners 120a, 120b, 140a, 140b to absorb the moment My and the forces Fx along the longitudinal axis.

This device 110 for absorbing thrust forces comprises two force absorbing rods 111, 112 symmetrically arranged on either side of the turbojet engine median plane XZ axis.

These rods are mounted, at the upstream end thereof, via anchoring points on the main portion of the intermediate housing 30 and at the downstream end thereof by means of a yoke 113 on the lower side of the lower spar 13.

These two lateral rods 111, 112 are each articulated at the downstream end thereof, on the yoke 113 for example by ball joints.

Each rod may be provided with clevises, particularly, two, in order to cooperate with a clevis preserved on the yoke 113 or conversely.

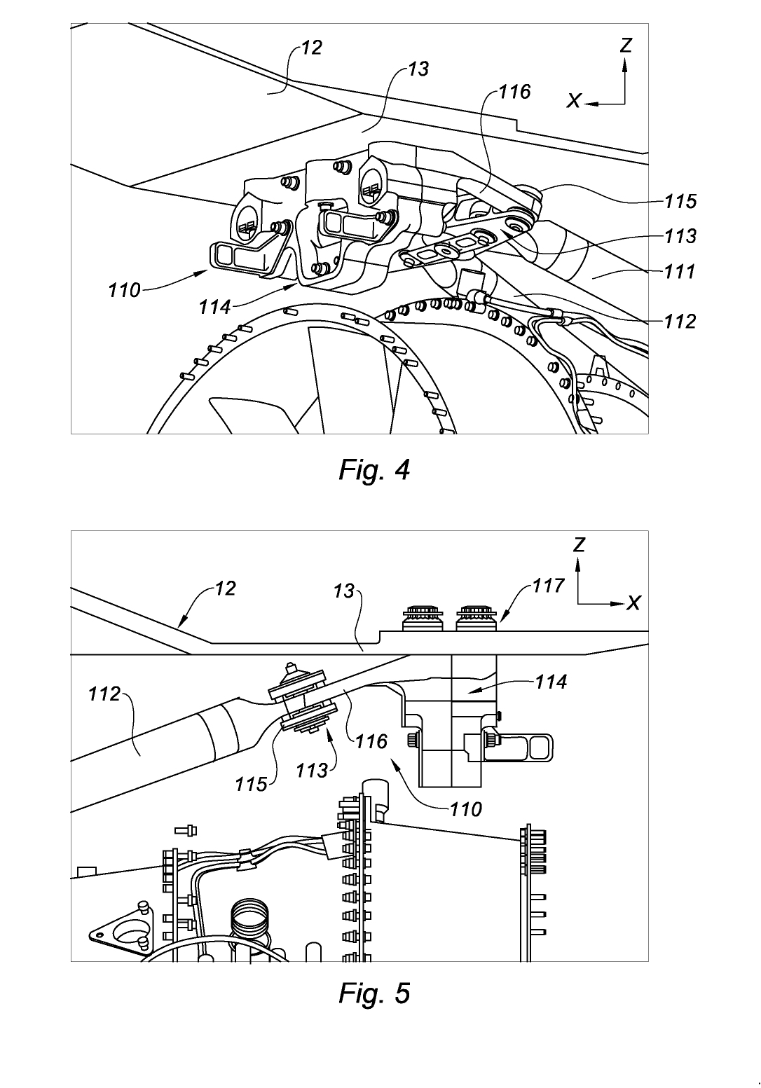

This yoke 113 is itself pivotally mounted with respect to a latching support 114 along an axis parallel with the axial connections of the rods 111, 112 with said yoke 113 (see FIG. 4).

More specifically, the yoke 113 comprises at its two opposite free ends, two parallel latching clevises 115 adapted to form with the support 114 connecting clevis 116 for providing load pathway redundancy.

The actual yoke 113 may be provided with a clevis for cooperating with two clevises preserved on the latching support 114.

Furthermore, the latching support 114 is integrally fixed to the lower spar 13 of the box 12 of the mast 10 by means of several axial connections 117 and possibly to shearing pins along Z.

In such a device for absorbing thrust forces 110, any fastener integral with the rear of the turbojet engine main housing 35 and/or the exhaust housing 37 is advantageously removed.

This device for absorbing thrust forces 110 may be designed to provide redundancy, in a non limiting example, by doubling it.

In order to absorb the moment My around the transversal axis, the two pairs of additional upstream suspension fasteners 120, 140, associated with the thrust absorbing device 110, are configured to absorb axial forces Fx of which the application points are shifted along the turbojet engine 2 vertical direction Z.

In order to absorb moment Mz around the vertical axis, the two pairs of additional upstream suspension fasteners 120, 140 are configured such as to absorb axial forces Fx along the approximately longitudinal direction, of which the application points are shifted along the direction Y.

The force component in the two pairs of upstream suspension fasteners 120, 140, outside the longitudinal direction X, is absorbed by the main upstream suspension fastener 130 described below.

The presence of two rods 120a, 120b and 140a, 140b for each of the upstream suspension fasteners 120, 140 enables to make these fasteners redundant. Hence, the loss of a part of the fasteners does not lead to the load pathway rupture.

With reference, in particular, to FIGS. 1 and 2, the first pair 120 of upstream suspension fasteners comprises two rods 120a, 120b, and the second pair 140 of first upstream suspension fasteners comprises two other rods 140a, 140b.

These four rods are mounted on the outer periphery of the outer ferrule 31 of the intermediate housing 30, at the downstream end of this ferrule 31.

These two pairs of fasteners 120, 140 are symmetrically mounted two by two with respect to the median plane XZ, defined by the turbojet engine axis X and axis Z.

These upstream fasteners 120, 140 extend in a plane XZ, and are connected at an upstream end upstream of the box 12 of the pylon 10.

They are shifted along Y.

It is worth noting that the pairs of first additional upstream suspension fasteners 120, 140 may be the following: a rod of each of the first and second pair of first upstream suspension fasteners, namely, 120a, 140a; 120a, 140b; 120b, 140a; 120b, 140b.

These pairs of upstream fasteners 120, 140 are mounted on either side of the main upstream suspension fastener 130.

The upstream suspension fasteners 120, 130, 140 are thus grouped together on the upper portion of the outer periphery of the outer ferrule 31 of the intermediate housing 30.

As illustrated on FIG. 2 more particularly, each pair of additional upstream suspension fasteners 120, 140 is mounted at each lateral end of the box 12 of the mast 10, on either side of the main upstream suspension fastener 130.

The two pairs of additional upstream suspension fasteners 120, 140 are thus shifted along Y, departing from the peripheral lateral end thereof, typically of the width of the box 12 of the mast 10.

As is visible in FIGS. 2 and 6 to 8, the two pairs 120, 140 of rods 120a, 120b on one side and 140a, 140b on the other side, are connected at an upstream end, by means of a yoke 150 to a fixing support 162 secured to the lower spar 13 of the box 12 of the mast 10 and at an upstream end to the outer ferrule 31 of the intermediate housing 30 via a latching support 160.

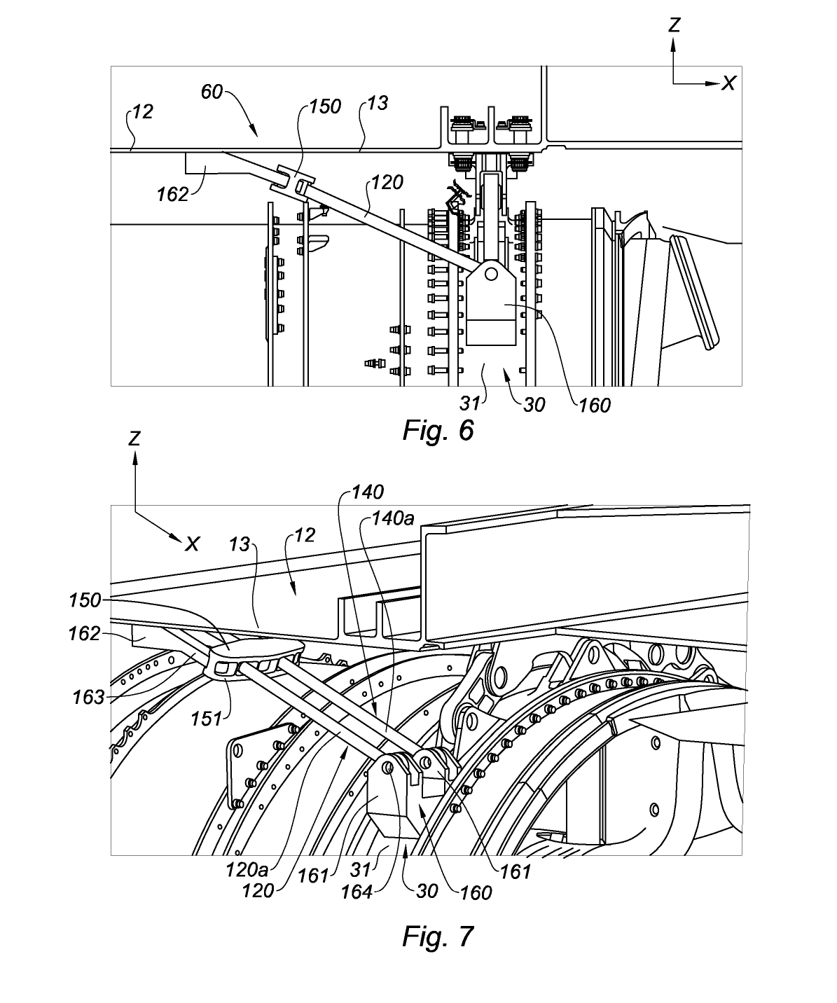

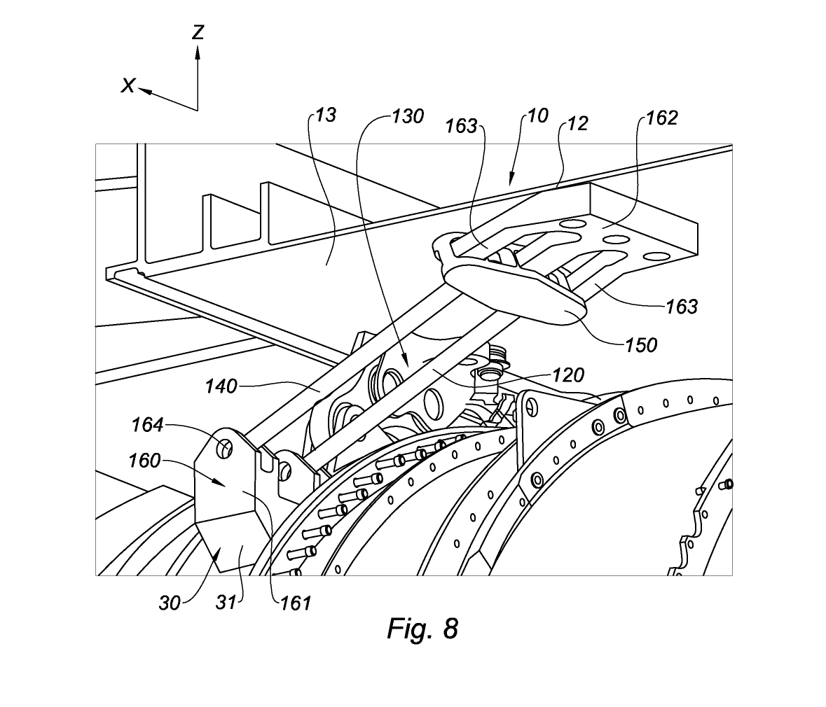

As is illustrated on FIGS. 7 and 8, the latching support 160 is mounted on the periphery of the outer ferrule 31 by means of adapted fixing means.

It may be particularly formed of one single piece with the housing 30 outer ferrule 31.

It may also be divided such as to have one or two clevises per rod 120, 140 in order to improve fastener redundancy.

This latching support 160 comprises two pairs of latching clevises 161 parallel with the plane XZ, shifted along Y and intended to cooperate with a member constituting the corresponding fastener and, more particularly with the downstream end of the corresponding latching rod 120a, 120b, 140a, 140b.

Alternatively, the support 160 may be provided with a clevis per rod to cooperate with two clevises preserved on the corresponding rod.

This latching support 160 is bent such as to exhibit the two pairs of clevises 161 protruding outwards of the periphery of the outer ferrule 31 extending along Z and at the same altitude Z.

In each of these clevises 161, an eyelet 164 is preserved to receive connecting means (not illustrated) intended to connect the clevis 160 and the corresponding rod 120a, 120b, 140a, 140b.

These eyelets 162 are preserved opposite eyelets preserved on the ends of the corresponding latching rods 120a, 120b, 140a, 140b.

The clevis or clevises of the latching support 160 and each rod 120a, 120b, 140a, 140b may be connected, for example, by adapted ball joints.

Furthermore, these latching rods 120a, 120b, 140a, 140b are articulated, at the upstream end thereof, on the yoke 150 by a ball joint connection.

As to the actual yoke 150, it is mounted on the upstream end of the box 12 lower spar 13 by means of the fixing support 162.

It is pivotally mounted with respect to this support 162 along its main axis perpendicular to the plane of the two rods 120a, 120b, 140a, 140b . . . .

The yoke 150 is provided with a system for limiting the rotation around its main axis for example by axes or pins mounted with clearance between the yoke 150 and outer legs 163 of the fixing support 162.

Furthermore, the fixing support 162 is integrally fixed with the upstream end of the lower spar 13 of the box 12 of the mast 10 by means of several axial connections along Z (for example: screws, pins, . . . ).

The set of rods 120a, 120b, 140a, 140b, associated with the latching system thereof (yoke 150, latching support 160 and fixing support 162) is designed such as to be redundant. The loss of any member of the load pathway does not lead to the total loss of this load pathway.

Other principles for obtaining load pathway redundancy are worth considering without departing from the scope of this present disclosure such as for example a rod mounted without clearance and a rod mounted with clearance so that this rod with clearance is active only if the load pathway of the other rod is ruptured.

The pairs 120, 140 of additional upstream suspension fasteners 120a, 120b, 140a, 140b may also be directed upstream of the pylon 10 or downstream of the pylon 10 for all described forms.

In order to absorb moment Mx along the longitudinal axis of the turbojet engine, the main upstream suspension fastener 130 is fixed on the outer ferrule 31 of the intermediate housing 30.

This main upstream suspension fastener 130 is configured to absorb, as well as moment Mx, the transversal Fy and vertical Fz forces.

It may be observed a form of this fastener on FIG. 2 in particular.

This fastener 130 is exhibited as a shoeing 131 comprising two symmetrical semi-fasteners with respect to the median plane XYYZ.

This shoeing 131 is connected at its two lateral ends to two latching clevises C1, C2 secured to the outer ferrule 31 of the intermediate housing 30 on which shackles 36 are respectively articulated at two or three points.

It is also connected to a latching clevis C3 secured to the outer ferrule 31 of the intermediate housing 30 at its center which acts as redundant load pathway in the event, for example of rupture of one of the shackles 36.

The clevis fixing means C1, C2, C3 may be any adapted fixing means and, particularly screws and shearing pins. The shackles 36 fixing means may be any adapted fixing means and particularly ball joints.

Furthermore, the shoeing 131 is also fixed to the lower spar 13 by adapted fixing means, which may comprise, in a non limiting manner, screwing means forming an axial connection along Z and pins.

It is worth noting that the shackles 36 may be of fail-safe type just as the shearing pins, the clevises C1, C2, C3 and/or the screwing means.

Other aircraft propulsion assemblies 1 may be considered without departing from the scope of the present disclosure.

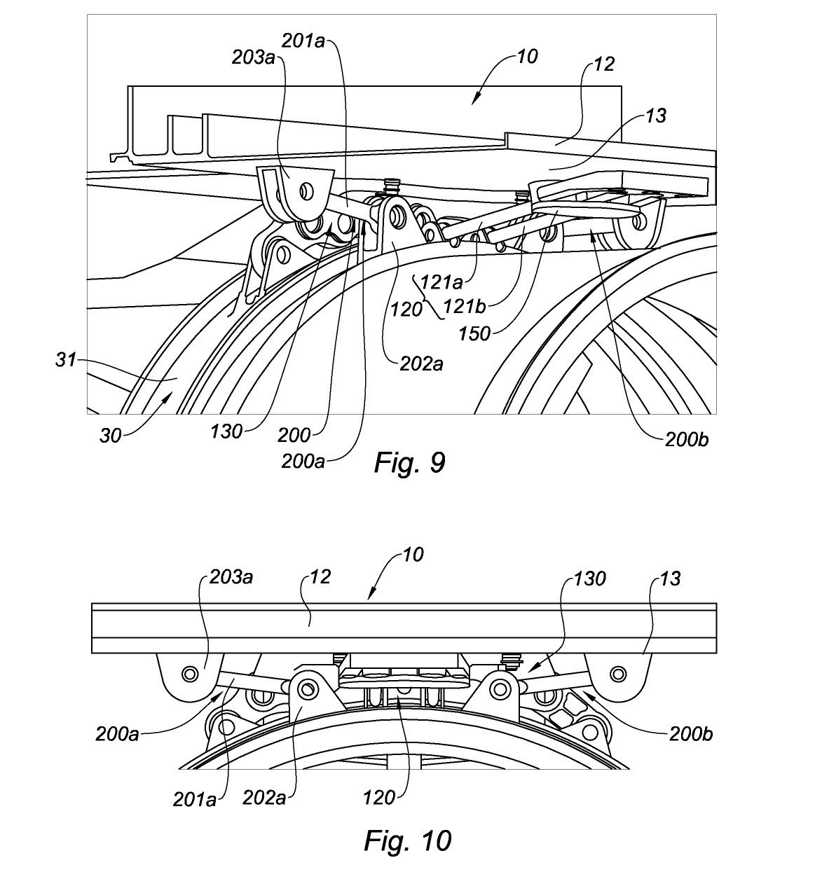

Thus, in an alternative form illustrated on FIGS. 9 and 10, it may be provided to absorb moment Mz by a pair of upstream suspension fasteners 200 separate from the suspension fastener 130 and configured such as to absorb in association with said main suspension fastener 130, moment Mz along the turbojet engine vertical axis.

The pair of upstream suspension fasteners 200 is configured to absorb forces Fy associated with the force absorption Fy along Y of the main suspension fastener 130.

These forces Fy have shifted application points along direction X.

Furthermore, it is shifted, the main upstream suspension fastener 130 absorbing moment Mx upstream of the outer ferrule 31 of the intermediate housing 30.

In another alternative form, the opposite is achieved, namely it is provided an upstream suspension fastener configured to absorb a force along axis Y at the upstream end of the ferrule 31 and the upstream suspension fastener 130 is shifted more downstream.

More particularly, the two suspension fasteners 200a, 200b are symmetrical with respect to the median plane XZ and shifted along Y.

These two suspension fasteners 200a, 200b extend in a plane YZ, connected at an end upstream of the box 12 of the pylon 10 and at an opposite end at the outer periphery of the outer ferrule 31 of the intermediate housing 30 or the fan housing 34.

One of these two suspension fasteners 200a, 200b is a standby pathway, mounted for example with some clearance, in case the other suspension fastener 200a, 200b ruptures.

Any other redundant system, such as for example a double rod is included within the scope of this present disclosure, the two fasteners 200a, 200b being one form of the redundancy function linked to the principle of the upstream suspension fasteners 200.

One single suspension fastener 200a will be described in relation with these figs.

It comprises a latching rod 201a extending in a plane YZ and fixed at one end respectively to a latching support 202a secured to the outer ferrule 31 of the intermediate housing 30 or the fan housing 34, and at the opposite end to a latching support 203a secured to the lower spar 13 of the pylon 10.

Each latching support 202a, 203a comprises two parallel clevises intended to cooperate with a clevis preserved at the end of the rod 201a of the corresponding suspension fastener 200a.

At each rod 201a end, the three clevises are connected together, for example by an adapted ball joint.

It is worth noting that it is also possible to have two parallel clevises on each rod 201a and a clevis on each corresponding latching support 202a, 203a.

In this alternative form, there is only one single pair 121a, 121b of first upstream suspension fasteners 120 placed in the plane XZ.

This pair of fasteners 120 is preserved between the two fasteners 200a, 200b.

This pair of fasteners 120 is similar to that described in connection with the other forms and will not be detailed any further below.

Thus, in this alternative form, the pairs of additional upstream suspension fasteners configured such as to absorb at least a moment Mz along the turbojet engine vertical axis and, associated with the device for absorbing thrust forces 110, a moment My along the turbojet engine transversal axis and forces Fx along the longitudinal axis of the turbojet engine may be the following:

a rod of the first pair of first upstream suspension fasteners, namely 121a or 121b and the upstream suspension fastener 200a, 200b configured to absorb a force along axis Y, namely pairs 121a, 200a or 121b, 200b or 121a, 200b or 121b, 200a.

By way of synthesis, the tables below resume the forces and moments absorbed by each of the suspension assembly means according to the present disclosure (device for absorbing thrust and upstream suspension fasteners):

First form (FIGS. 1 to 8):

| | Fx | Fy | Fz | Mx | My | Mz |
|---|---|---|---|---|---|---|
| Device 110 | X | | | | X | |
| Fasteners 120 | X | | | | X | X |
| (120a/120b) | | | | | | |
| Fasteners 140 | X | | | | X | X |
| (140a, 140b) | | | | | | |
| Fastener 130 | | X | X | X | | |

Second form (FIGS. 9 and 10):

| | Fx | Fy | Fz | Mx | My | Mz |
|---|---|---|---|---|---|---|
| Device 110 | X | | | | X | |
| Fasteners | X | | | | X | |
| 121a/121b | | | | | | |
| Fasteners 200 | | X | | | | X |
| (200a, 200b) | | | | | | |
| Fastener 130 | | X | X | X | | X |

As for the different suspension fasteners, for all the described forms, they can be achieved according to any form known by the skilled person, such as for example that pertaining to the assembling of shackles, yokes and shoeings intended to cooperate with a rod, or even a shearing pin type articulation system.

For all the described forms, these suspension fasteners, may however be provided with systems providing force transmission redundancy (forces and moments), for example doubled load pathways, standby load pathways, fail-safe axes namely provided with main connecting axes housed in concentric sleeves providing force transmission in the event of rupture of the main connecting axis or the sleeve, or other.

The suspension assembly 100 is generally isostatic.

Thanks to the suspension assembly 10 according to the present disclosure, the set of loads (forces and moments) is absorbed on the turbojet engine 2 upstream plane.

Any fastener on the rear of the turbojet engine 2 main housing or on the exhaust housing is absent, thus highly reducing turbojet engine 2 deformation risks and particularly bending thereof during its different operating regimes.

The contacts between the turning components of the turbojet engine 2 and the corresponding housings are decreased, thus improving engine service life.

Furthermore, the number of fasteners located in the secondary flow channel being decreased, disturbances due to the presence of these fasteners in this channel are in turn decreased, thus improving propulsion assembly performance.

What is claimed is:

1. An aircraft propulsion assembly comprising a turbojet engine, a support providing a transfer of force torque to an aircraft from a suspension assembly and said suspension assembly interposed between said support and the turbojet engine,
wherein the suspension assembly comprises a device for absorbing thrust forces of the turbojet engine, said device mounted on an intermediate housing or at a front of a main housing of said turbojet engine and on said support,
wherein the suspension assembly further comprises upstream suspension fasteners mounted on at least one of a fan housing and said intermediate housing of said turbojet engine:
at least one main upstream suspension fastener configured to absorb at least a moment (Mx) along a longitudinal axis (X) of the turbojet engine as well as forces (Fy and Fz) in a plane perpendicular to the longitudinal axis of said turbojet engine, and
at least one pair of additional upstream suspension fasteners separate from the main upstream suspension fastener and configured to absorb at least a moment (Mz) along an axis (Z) leading from the longitudinal axis of the turbojet engine to a longitudinal axis of the support and, associated with the device for absorbing thrust forces, a moment (My) along an axis (Y) perpendicular to the longitudinal axis (X) of the turbojet engine and to the axis (Z) leading from the longitudinal axis of the turbojet engine to the longitudinal axis of the support of the turbojet engine and forces (Fx) along the longitudinal axis of the turbojet engine.

2. The aircraft propulsion assembly according to claim 1, wherein the suspension assembly comprises load pathway redundancies by means of pairs of suspension fasteners in order to provide resumption of load pathways in an event of rupture of a main load pathway.

3. The aircraft propulsion assembly according to claim 1, wherein the suspension assembly is isostatic.

4. The aircraft propulsion assembly according to claim 1, wherein said at least one pair of additional upstream suspension fasteners extends in a plane defined by the longitudinal axis (X) of the turbojet engine and the axis (Z) leading from the longitudinal axis of the turbojet engine to the longitudinal axis of the support, each fastener being connected, at an upstream end, to an upstream of the support and, at a downstream end, to an outer periphery of an outer ferrule of the intermediate housing or the fan housing.

5. The aircraft propulsion assembly according to claim 4, wherein said at least one pair of additional upstream suspension fasteners is mounted on the outer ferrule of the intermediate housing or on the fan housing, symmetrically with respect to a median plane defined by the longitudinal axis (X) of the turbojet engine and by the axis (Z) leading from the longitudinal axis of the turbojet engine to the longitudinal axis of the support.

6. The aircraft propulsion assembly according to claim 5, wherein said at least one pair of additional upstream suspension fasteners is mounted on either side of the main upstream suspension fastener and extends in a plane perpendicular to the longitudinal axis (X) of the turbojet engine.

7. The aircraft propulsion assembly according to claim 6, wherein said at least one pair of additional upstream suspension fasteners is configured to absorb the forces (Fx) of which application points are shifted along a vertical direction (Z) leading from the longitudinal axis of the turbojet engine to the longitudinal axis of the support.

8. The aircraft propulsion assembly according to claim 6, wherein said at least one pair of additional upstream suspension fasteners is configured to absorb the forces (Fx) along a longitudinal direction, of which application points are shifted along a direction (Y).

9. The aircraft propulsion assembly according to claim 3, wherein each pair of the additional upstream suspension fasteners comprises two parallel latching rods and extending in a plane defined by the axis (Z) leading from the longitudinal axis (X) of the turbojet engine to the longitudinal axis of the support and by the longitudinal axis of the turbojet engine, connected at an upstream end, by means of a yoke, to a fixing support secured to the support and, at a downstream end, to the intermediate housing or the fan housing via a latching support.

10. The aircraft propulsion assembly according to claim 1, wherein said at least one pair of additional upstream suspension fasteners comprises:
a fastener of a pair of upstream suspension fasteners extending in a plane defined by the longitudinal axis (X) of the turbojet engine and the axis (Z) leading from the longitudinal axis of the turbojet engine to the longitudinal axis of the support, each fastener being connected to the support and, at a downstream end, to an outer periphery of the intermediate housing or the fan housing; and
a fastener configured to absorb in association with said main upstream suspension fastener, the moment (Mz) along the axis (Z) leading from the longitudinal axis (X) of the turbojet engine to the longitudinal axis of the support.

11. The aircraft propulsion assembly according to claim 10, wherein said fastener extends in a plane perpendicular to the longitudinal axis (X), allowing to absorb forces (Fy) perpendicular to the longitudinal axis (X) and to the axis (Z) leading from the longitudinal axis (X) to the longitudinal axis of said support.

12. The aircraft propulsion assembly according to claim 11, wherein said fastener comprises a latching rod extending in a plane YZ and fixed at one end respectively to a latching support secured to the intermediate housing or the fan housing, and at the opposite end to a latching support secured to a pylon.

13. The aircraft propulsion assembly according to claim 2, wherein said at least one pair of additional upstream suspension fasteners is configured to absorb in association with said main suspension fastener, the moment (Mz) along the axis (Z) leading from the longitudinal axis (X) of the turbojet engine to the longitudinal axis of the support, said at least one pair of additional upstream suspension fasteners comprising two fasteners symmetrical with respect to the median plane (XZ) and shifted along the axis (Y).
